(19) United States
(12) Patent Application Publication
(10) Pub. No.: US 2008/0052678 A1
(43) Pub. Date: Feb. 28, 2008

(54) Method for Providing Annotated Transaction Monitoring Data for Initially Hidden Software components

(75) Inventors: Bryan Christopher Chagoly, Austin, TX (US); Andrew Jason Lavery, Austin, TX (US); Kirk Malcolm Sexton, Austin, TX (US)

Correspondence Address: IBM CORP (YA);C/O YEE & ASSOCIATES PC, P.O. BOX 802333, DALLAS, TX, 75380, US

(73) Assignees: Bryan Christopher Chagoly, Austin, TX (US); Andrew Jason Lavery, Austin, TX (US); Kirk Malcolm Sexton, Austin, TX (US)

(21) Appl. No.: 11/462,746

(22) Filed: Aug. 7, 2006

(51) Int. Cl. G06F 9/44

(52) U.S. Cl. 717/124

(57) ABSTRACT

Method and apparatus is directed to a software system associated with a sequence of transactions, wherein the software system includes one or more programs. In embodiments of the invention, a runtime stack trace of an executing program is used to determine initially hidden software components that are interspersed between initially known or recognized components of the software system. In one embodiment, a method pertains to a software system provided to implement a sequence of transactions, wherein each transaction corresponds to a component of the software system. A transaction monitor probe is configured to recognize pre-specified software components, including components of the software system that correspond to some of the transactions. The probe recognizes each of the pre-specified components included in the software system, wherein recognized components include components corresponding to first and second sequential transactions. Context information is acquired, that pertains to each component of the system positioned between the first and second transactions. The context information is then used to identify components that are not pre-specified components of the probe.

### BACKGROUND OF THE INVENTION

1. Field of the Invention

The invention disclosed and claimed herein generally pertains to a mechanism or method for monitoring transactions that are associated with a software system, wherein the software system comprises a configuration of software components. More particularly, the invention pertains to a method of the above type wherein transactions in a sequence are respectively implemented by corresponding software components, and some of the transactions are initially monitored to acquire data. Even more particularly, the invention pertains to a method of the above type wherein the monitored transaction data is annotated with information pertaining to software components that are initially unrecognized or hidden.

2. Description of the Related Art

As is known by those of skill in the art, a transaction involving e-commerce, such as purchase of a book over the Internet, may in fact comprise a sequence of transactions or subtransactions. Thus, in the book purchase example there is the transaction of placing an order for a book on-line. Other transactions required for the complete purchase would include entering the order, billing, and arranging to ship the book to the purchaser. Generally, the entire book purchase procedure, or over-all transaction, is carried out by implementing an associated software system, wherein the system comprises a configuration of software components that correspond to respective transactions of the transaction sequence.

As is further well known, software-based transactions of the above type can be modeled by monitoring and recording correlations between various components of the software system. Data from the transaction monitoring procedure can then be analyzed, to determine how the various parts of the software system are performing. A typical transaction monitoring system uses byte code insertion or system defined callbacks to instrument software. One example of such a monitoring tool is known as the Tivoli Composite Application Manager (TCAM), which monitors J2EE applications. TCAM is a product that is made available by International Business Machines Corporation (IBM), and Tivoli is a registered trademark of IBM. TCAM models transactions of the above type, and can report various views of the transaction model, including a graphical view. Such view may show, for example, a transaction invoking a subtransaction, which in turn invokes two other subtransactions.

Transaction monitoring systems of the above type are very useful, in that they provide detailed timing and context information at each point where transactions are being monitored. However, a drawback of these monitoring systems is that they can only monitor transactions associated with software components that the monitoring system has been programmed to recognize. For instance, TCAM is able to recognize transactions associated with Servlets and standard Java interfaces such as Enterprise Java Beans (EJBs), Java Data Base Connectivity (JDBC),and Remote Method Invocation (RMI). However, a software system typically has user-defined or other software components that are not one of the Servlet, EJB or other components recognized by TCAM or other conventional monitoring tool. Thus, such user-defined or other software components will be hidden from and remain unknown to transaction monitoring tools of the type currently available, even if such other components are present in a software system. Clearly, it would be desirable to provide a more flexible mechanism that could discover or recognize and monitor all such hidden software components.

### SUMMARY OF THE INVENTION

A software system associated with a sequence of transactions, as described above, will generally include one or more programs. In embodiments of the invention, a runtime stack trace of an executing program is used to determine initially hidden software components that are interspersed between initially known or recognized components of the software system. More particularly, the runtime stack trace can provide all the software components traversed by a program, as the program proceeds from one transaction in a sequence to the next transaction or substransaction. One useful embodiment of the invention is directed to a method associated with a software system provided to implement a procedure comprising a sequence of transactions, wherein each transaction corresponds to a component of the software system. The method includes the step of configuring a transaction monitor probe to recognize pre-specified software components, wherein the pre-specified components include some of the components of the software system that correspond to transactions. The probe is operated to recognize each of the pre-specified components that are included in the software system, wherein one of the recognized components corresponds to a first one of the transactions, and another of the recognized components corresponds to a second transaction that follows the first transaction in the sequence. The method further includes acquiring context information pertaining to each software component of the system that is positioned between the first and second transactions.

As used herein, “context information” refers to information that has been stored while software is being executed between first and second transactions. Context information specifically includes information that is contained in a runtime stack trace taken between the two transactions. The stack trace identifies all software components executed therebetween. Accordingly, context information, including the stack trace, can be used to identify components of the software system that are not pre-specified software components recognizable by the probe.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram showing a data processing system of a type that may be used in implementing an embodiment of the invention.

FIG. 2 is a schematic diagram depicting transactions of a transaction sequence, wherein each transaction corresponds to a software component that can be recognized by a currently available transaction monitoring tool.

FIG. 3 is a schematic diagram depicting the transactions of FIG. 2 interspersed with other transactions corresponding to software components that are hidden to the tool of FIG. 2.

FIG. 4 is a flow chart showing steps of a method comprising an embodiment of the invention.

### DETAILED DESCRIPTION OF THE PREFERRED EMBODIMENT

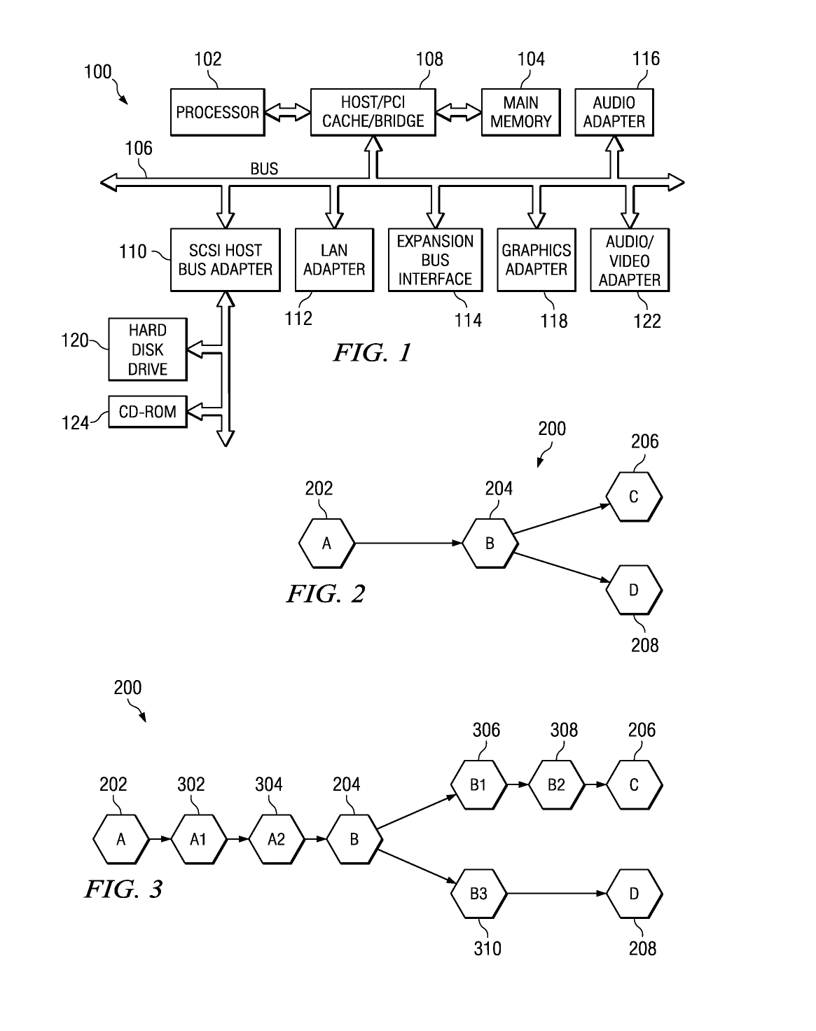

Referring to FIG. 1, there is shown a block diagram of a generalized data processing system 100 which may be used in implementing embodiments of the present invention. Data processing system 100 exemplifies a computer, in which code or instructions for implementing the processes of the present invention may be located. Data processing system 100 usefully employs a peripheral component interconnect (PCI) local bus architecture, although other bus architectures such as Accelerated Graphics Port (AGP) and Industry Standard Architecture (ISA) may alternatively be used. FIG. 1 shows a processor 102 and main memory 104 connected to a PCI local bus 106 through a Host/PCI bridge 108. PCI bridge 108 also may include an integrated memory controller and cache memory for processor 102.

Referring further to FIG. 1, there is shown a local area network (LAN) adapter 112, a small computer system interface (SCSI) host bus adapter 110, and an expansion bus interface 114 respectively connected to PCI local bus 106 by direct component connection. Audio adapter 116, a graphics adapter 118, and audio/video adapter 122 are connected to PCI local bus 106 by means of add-in boards inserted into expansion slots. SCSI host bus adapter 110 provides a connection for hard disk drive 120, and also for CD-ROM drive 124.

An operating system runs on processor 102 and is used to coordinate and provide control of various components within data processing system 100 shown in FIG. 1. The operating system may be a commercially available operating system such as Windows XP, which is available from Microsoft Corporation. Instructions for the operating system and for applications or programs are located on storage devices, such as hard disk drive 120, and may be loaded into main memory 104 for execution by processor 102.

Referring to FIG. 2, there is shown a procedure 200 that is implemented by means of a corresponding software system, comprising a configuration of software components. Procedure 200 includes a sequence of transactions or subtransactions 202-208, also designated as A-D, respectively. The software components are included in one or more programs, which may be used with a data processing system such as system 100. As the programs are successively executed, transaction A is carried out, followed by transaction B and then transactions C and D. Transaction B is in fact a subtransaction invoked by transaction A, so that A is the parent of subtransaction B. Transactions C and D, in turn, are subtransactions of transaction B, which is their parent transaction.

Transactions A-D respectively correspond to components of the software system, and each transaction is carried out as its corresponding software component is traversed during execution of the software system programs. Moreover, each of these corresponding software components is of a type that will be recognized by a currently available transaction monitoring system, such as TCAM, as described above. As stated previously, TCAM is able to recognize standard Java interfaces such as Servlets, EJBs, JDBC and RMI. Transactions associated with these types of components tend to be critical parts of an over-all transaction or procedure such as procedure 200. Accordingly, a first step in an embodiment of the invention is to operate a transaction monitoring system or probe, such as TCAM or the like, to detect or recognize the software components corresponding to transactions A-D. The monitoring system is able to model these transactions and can provide a graphical view thereof, such as the view shown by FIG. 2.

A representation such as FIG. 2 is able to provide useful timing and context information in connection with each of the transactions A-D of procedure 200. However, the software system that implements procedure 200 will generally contain more software components than those shown in FIG. 2. Typically, a software system has user defined software components that are not one of those recognized by currently available transaction monitoring systems such as TCAM. The software system may also have other software components, written by the operating system/middleware or other non-user code, that are also not recognized by a current transaction monitoring system. For instance, a Servlet may make a call into JDBC. The software components between the Servlet and HDBC calls may be written by the user or they may be written by someone else, for instance, they could be software provided by the Java Runtime Environment (not written by the user), or they could be software written by a database vendor like IBM or Oracle.

As used herein, the term “hidden” software component is defined to mean all software components, whether defined by the user, the operating system/middleware or other non-user code, that are not recognized by currently available transaction monitoring systems such as TCAM. It is to be emphasized that a hidden or unrecognized software component may be a major source of delay or other unwanted effect, when the software system is used to implement procedure 200. Accordingly, as a further step in an embodiment of the invention, a more flexible mechanism is provided to recognize or detect user defined and other hidden or initially unknown software components, and to monitor and model them. FIG. 3 shows a representation that includes such user defined or other software components that are initially hidden to the transaction analyst.

Referring to FIG. 3, there is shown procedure 200 of FIG. 2 enhanced to include the transactions 302-310, also referenced as A1-A2 and B1-B3, respectively. A1 and A2 correspond to hidden software components traversed by a program of the software system that is executed when transaction A calls subtransaction B. Accordingly, at subtransaction B a runtime stack trace is used to get a call stack showing all the components that were traversed in getting from A to B. This is carried out as follows:

| | | |
|---|---|---|
| A (String) | calls | A1 (int) |
| A1 (int) | calls | A2 (Long, Long) |
| A2 (Long, Long) | calls | B (String□) |

Similarly, the runtime system is used to detect or recognize previously hidden software components corresponding to transactions B1 and B2, between transactions B and C, and to transaction B3 between transactions B and D. These software components and their corresponding transactions were previously hidden, since they could not be recognized by currently available transaction monitoring systems. By annotating procedure 200 with the additional transactions of FIG. 3, greater detail is provided regarding the flow of the transaction. This greater detail can help diagnose performance problems with the software system associated with procedure 200.

It is clearly beneficial to discover and provide annotation for initially hidden transactions such as A1-A2 and B1-B3. For example, a user may thereby be able to determine that transactions involving component A1 are always slow, while transactions that do not involve A1 execute quickly. By making the user aware of transaction A1 and characteristics of its corresponding software component, the user would realize that transaction A1 was the source of the delay problem, rather than A or B being the source of the problem.

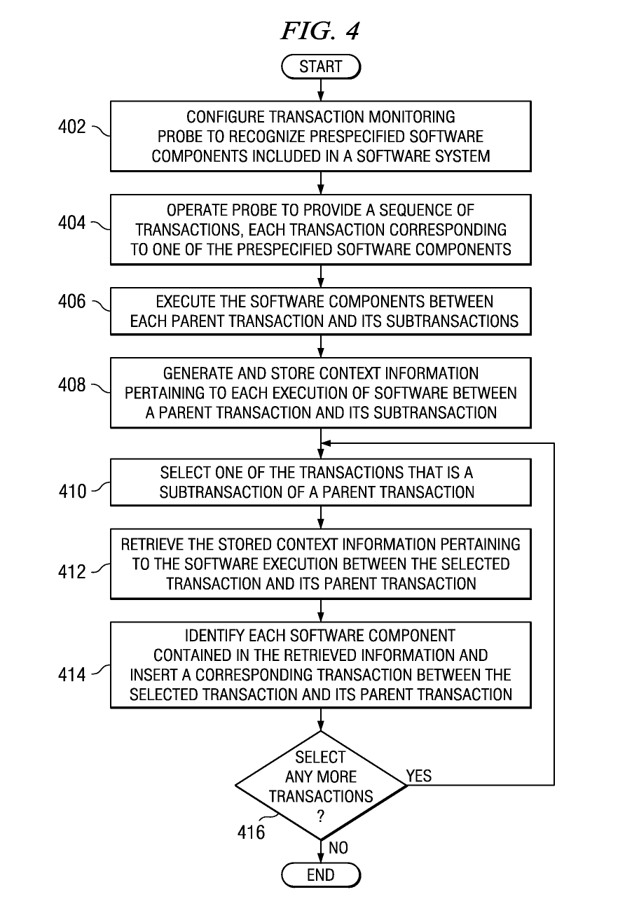

Referring to FIG. 4, there is shown a flow chart depicting respective steps of an embodiment of the invention. In accordance with step 402, a transaction monitoring system or probe, such as TCAM, is configured to recognize certain pre-specified software components that are likely to be found in the software system, including those that produce respective transactions A-D. These could include the above-mentioned components EJB, JDBC and RMI, but the invention is not limited thereto.

Step 404 of FIG. 4 shows the probe operated to recognize a sequence of transactions such as A-D shown in FIG. 2, as previously described, wherein A-D respectively correspond to at least some of the pre-specified software components of step 402.

Following step 402, a decision should be made as to whether more detailed information should be collected, such as information pertaining to the intermediary transactions A1-A2 and B1-B3 shown in FIG. 3. This decision, shown by step 405, is made dynamically and can be made, for instance, by looking at the transaction correlator token to see if a bit is set in the correlator indicating that detailed transaction information should be gathered. The advantage of this is that overhead of collecting detailed transaction information is only incurred when the correlator bit is set to gather detailed information. Thus, if it is decided at step 405 not to collect the detailed information, the process shown by FIG. 4 is ended. Otherwise, the process continues with step 406.

Step 406 pertains to execution of software system programs that contain software components lying between parent transactions and each of their subtransactions. As described above, a transaction A-D that is immediately followed in the A-D sequence by another transaction is the parent of the immediately following transaction. Conversely, the following transaction is a subtransaction of the parent transaction. Thus, as execution step 406 is carried out, all software components between a parent transaction and a subtransaction are traversed by the execution.

In accordance with step 408, context information is stored and generated, as the software between each parent and its subtransaction is executed. This may be carried out by means of the transaction monitoring probe, using a method such as the following:

```
startProbeOfJDBCobject(Methodinfo mi) {
  parentCorrelatorToken = getParent( );
  contextinformation[0] = mi.getSQLStatement( );
  //Sample context information for JDBC probe
  contextinformation[1] = mi.getDatabaseName( );
  //Sameple context information for JDBC probe
  currentCorrelatorToken =
  startTransaction(parentCorrelatorToken,
  contextInformation);
  }
  endProbeOfJDBCOjbect(MethodInfo mi) {
  currentCorrelatorToken =
  getCurrentCorrelator( );
  stopTransaction(currentCorrelatorToken);
  }
```

The startProbe records context information as the execution proceeds from the parent to the subtransaction, and it starts a timer to record the beginning of the transaction time. The endProbe method stops the timer to record the end of such transaction time. If the parent selected at the getParent of the above method is transaction A, the context information stored during the method will include the stack trace between transactions A and B. The stack trace will identify all calls between A and B, as the software therebetween is being executed. Accordingly, the presence of the software components corresponding to A1 and A2, lying between transactions A and B, will be indicated by the stored CONTEXT INFORMATION.

Referring further to FIG. 4, step 410 shows selection of a transaction that is a subtransaction of a parent. For example, transaction B, the subtransaction of parent A, could be selected. After this selection, step 412 indicates retrieval of the context information that pertains to the software execution between the selected transaction and its parent. This retrieval may be implemented by modifying the above startProbe method to look at the pertinent stack trace. This new startProbe will contain context information which will include the callstack from the parent transaction to the selected transaction. The modified method is as follows:

```
startProbeOfJDBCobject(Methodinfo mi) {
  parentCorrelatorToken = getParent( );
  parentMethodName = getParentMethodName( );
  Exception e = new Exception( ); //The
  Exception object contains the stack trace
String0 callStackTraversedSinceParent =
FindChildrenOfParentMethodName
(e,parentMethodName);
contextInformation(0) = mi.getSQLStatement( );
//Sample context information for JDBC probe
contextInformation[1] = mi.getDatabaseName( );
//Sample context information for JDBC probe
contextInformation[2] =
“TRAVERSED_CALLSTACK_BEGIN”;
for(int i=0;
i<callStackTraversedSinceParent.length; i++) {
  contextInformation[i+3] =
  callStackTraversedSinceParent[i];
}
contextInformation
[callStackTraversedSinceParent.length+3] =
“TRAVERSED_CALLSTACK_END”;
currentCorrelatorToken = startTransaction
(parentCorrelatorToken, contextInformation);
```

The above method uses Exception e=new Exception to contain the stack trace. If the parent is transaction A, the stack trace would show the path followed in proceeding from transaction A to transaction B. Thus, the trace would include the software components corresponding to transactions A1 and A2. Thus, the software components would be identified as children of transaction A, in accordance with step 414, and A1 and A2 would be inserted between transactions A and B, as shown by FIG. 3.

Following step 414, it is necessary to determine whether or not any further transaction is to be selected for analysis as a subtransaction, in order to determine if there are any user defined or other hidden software components between it and its parent. This determination is indicated as step 416. If the conclusion of step 416 is a NO, the process of FIG. 4 ends. Otherwise, the process returns to step 414 and selects a new transaction.

For many applications, it would be preferable to carry out steps 410, 412 and 414 for only some, and not all, of the subtransactions of a procedure 200. As stated above, this practice would avoid excessive overhead.

The invention can take the form of an entirely software embodiment or an embodiment containing both hardware and software elements. In a preferred embodiment, the invention is implemented in software, which includes but is not limited to firmware, resident software or microcode.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In association with a software system provided to implement a procedure comprising a sequence of transactions, wherein the software system comprises a configuration of software components and each transaction corresponds to one of the components, a method comprising the steps of:
configuring a transaction monitor probe to recognize pre-specified software components, said pre-specified software components including some of the components of said software system that correspond to transactions of said sequence;
operating said probe to recognize each of said pre-specified components that is included in said software system, one of said recognized components corresponding to a first of said transactions, and another of said recognized components corresponding to a second of said transactions that follows said first transaction in said sequence;
acquiring context information pertaining to each software component of said software system that is positioned between said first and second transactions; and
using said context information to identify components of said software system that are not pre-specified software components recognizable by said probe.

2. The method of claim 1, wherein:
said context information is acquired by generating a call stack during execution of all software components of said system that are positioned between said first and second transactions.

3. The method of claim 2, wherein:
said call stack contains information identifying one or more of said software components that are not pre-specified components.

4. The method of claim 3, wherein:
at least one of said software components identified by information in said call stack is a hidden software component, each of said hidden software components selected from a group that includes at least software components defined by a user, by the operating system/middleware or by other non-user code.

5. The method of claim 4, wherein:
a stack trace is used to provide selected annotated data pertaining to said hidden software components.

6. The method of claim 5, wherein:
an exception object is used by said probe to provide said stack trace.

7. The method of claim 1, wherein:
said software components that are not pre-specified components are monitored to acquire data showing the time required to carry out transactions that respectively correspond to said pre-specified components that are recognizable by said probe.

8. The method of claim 1, wherein:
said procedure comprises an end-to-end commercial transaction.

9. A computer program product in a computer readable medium for use with a software system provided to implement a procedure comprising a sequence of transactions, wherein each transaction corresponds to a component of the software system, said computer program product comprising:
first instructions for configuring a transaction monitor probe to recognize pre-specified software components, said pre-specified software components including some of the components of said software system that correspond to transactions of said sequence;
second instructions for operating said probe to recognize each of said pre-specified components that are included in said software system, one of said recognized components corresponding to a first of said transactions, and another of said recognized components corresponding to a second of said transactions that follows said first transaction in said sequence;
third instructions for acquiring context information pertaining to each software component of said software system that is positioned between said first and second transactions; and
fourth instructions for using said context information to identify components of said software system that are not pre-specified software components recognizable by said probe.

10. The computer program product of claim 9, wherein:
said context information is acquired by generating a call stack during execution of all software components of said system that are positioned between said first and second transactions.

11. The computer program product of claim 10, wherein:
said call stack contains information identifying one or more of said software components that are not pre-specified components.

12. The computer program product of claim 11, wherein:
at least one of said software components identified by information in said call stack is a hidden software component, each of said hidden software components selected from a group that includes at least software components defined by a user, by the operating system/middleware or by other non-user code.

13. The computer program product of claim 12, wherein:
a stack trace is used to provide selected annotated data pertaining to said hidden software components.

14. The computer program product of claim 13, wherein:
an exception object is used by said probe to provide said stack trace.

15. Apparatus for use with a software system provided to implement a procedure comprising a sequence of transactions, wherein each transaction corresponds to a component of the software system, said apparatus comprising:
a transaction monitor probe configured to recognize pre-specified software components, said pre-specified software components including some of the components of said software system that correspond to transactions of said sequence;
means for operating said probe to recognize each of said pre-specified components that are included in said software system, one of said recognized components corresponding to a first of said transactions, and another of said recognized components corresponding to a second of said transactions that follows said first transaction in said sequence;
means for acquiring context information pertaining to each software component of said software system that is positioned between said first and second transactions; and
means for using said context information to identify components of said software system that are not pre-specified software components recognizable by said probe.

16. The apparatus of claim 15, wherein:
said context information is acquired by generating a call stack during execution of all software components of said system that are positioned between said first and second transactions.

17. The apparatus of claim 16, wherein:
said call stack contains information identifying one or more of said software components that are not pre-specified components.

18. The apparatus of claim 17, wherein:
at least one of said software components identified by information in said call stack is a hidden software component, each of said hidden software components selected from a group that includes at least software components defined by a user, by the operating system/middleware or by other non-user code.

19. The apparatus of claim 18, wherein:
a stack trace is used to provide selected annotated data pertaining to said hidden software components.

20. The apparatus of claim 19, wherein:
an exception object is used by said probe to provide said stack trace.
